(19) United States
(12) Patent Application Publication
(10) Pub. No.: US 2011/0295626 A1
(43) Pub. Date: Dec. 1, 2011

(54) INFLUENCE ASSESSMENT IN SOCIAL NETWORKS

(75) Inventors: Wei Chen, Beijing (CN); Yajun Wang, Beijing (CN); Siyu Yang, Princeton, NJ (US); Chi Wang, Champaign, IL (US)

(73) Assignee: Microsoft Corporation, Redmond, WA (US)

(21) Appl. No.: 12/790,075

(22) Filed: May 28, 2010

(51) Int. Cl. G06N 5/02; G06Q 99/00; G06Q 10/00

(52) U.S. Cl. 705/7.11; 706/54; 706/52

(57) ABSTRACT

Social networks have become platforms to disseminate and market information and ideas. A social network, users, and interactions of users may be modeled by graphs, which may be analyzed to determine influential users. In one example, nodes within a graph may be concurrently grouped into node groupings. Influence values corresponding to node counts within node groupings may be assigned to nodes within node groupings. Influential nodes may be determined based upon the assigned influence values. In another example, degrees of nodes (e.g., an edge count of a node) may be used to determine influential nodes within the graph. Upon selecting a node, degrees of neighboring nodes of the selecting node may be discounted because the node was selected. In another example, trees corresponding to a current node and (e.g., maximum) influential paths from other nodes to the current node may be constructed and evaluated to determine a group of nodes.

### BACKGROUND

Many online users incorporate social networking into their online experience. For example, a user may join a social network comprising a variety of users, companies, and/or other entities. Within the social network, users may generate user profiles that may be shared with other users. The users may be able to join groups and create relationships. Furthermore, users may share events, images, comments, ideas, and/or other content with other users. In this way, a social network becomes a powerful tool for disseminating information that may be adopted by other users. For example, user Dan may share a suggestion that a particular laptop model is rich in features. Other users may notice the suggestion, and may either adopt the suggestion (e.g., purchase the laptop), support the suggestion (e.g., give a positive reaction to the suggestion), or reject the suggestion (e.g., make a statement that the laptop is lacking in features). In this way, a “word of mouth” effect is created within the social network. When promoting a product or an idea, it may be advantageous to determine a group of users to promote the product or idea through, where the group of users has a large spread of influence within the social network. This allows for the promotion of the product or idea to reach a large population of users that may adopt the product or idea.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for determining influence of nodes within a graph are disclosed herein. In one example, one or more systems and/or techniques for assigning influence values to nodes within a graph are disclosed. In another example, one or more systems and/or techniques for selecting one or more nodes within a graph are disclosed. In another example, one or more systems and/or techniques for determining a node having a desired influence within a graph are disclosed. It may be appreciated that a graph may comprise nodes and edges connecting nodes. It may be appreciated that the graph may be directed or undirected. In one example, a node may represent an object (e.g., a user) within a social network. An edge may represent an influence probability between a user pairing (e.g., a first user and a second user connected by the edge). In one example, the influence probability may represent a probability that information (e.g., a suggestion or advice) provided by a first user may influence a decision of the second user. For example, a first user may suggest to a second user that ordering pizza from a particular vendor is a good idea. The influence probability may reflect a likelihood that the second user would adopt the suggestion and order pizza from that vendor.

In one example of assigning influence values to nodes within a graph, a determination may be concurrently made as to whether edges between nodes are activated or deactivated. It may be appreciated that concurrently determining whether edges are activated or deactivated may, for example, be performed simultaneously for all edges within the graph. In one example, a random function, weighted based upon influence probabilities of edges, may be performed upon the edges to determine activation/deactivation. Node groupings may be concurrently determined, where a node grouping comprises one or more nodes connected with activated edges. It may be appreciated that nodes within the graph may be grouped by activated edges because deactivated edges may be treated as non-existent. Influence values may be assigned to nodes within the node groupings. In one example, an influence value may correspond to a node count of a node group.

It may be appreciated that the technique described may be performed a desired number of times (e.g., ten-thousand times) to compute an average influence value for respective nodes. It may be appreciated that the graph may be reinitialized between executions of the techniques described. It may be appreciated that reinitializing of the graph may comprise removal of edge activation/deactivation designations, node groupings, and/or assigned influence values. It may be appreciated that the technique described may provide different or the same activated/deactivated edges, node groupings, and/or influence values from one execution to another because randomness may be involved in determining edge activation.

An influential node may be determined within the graph based upon a node having a desired influence value (e.g., a largest influence value, a smallest influence value, an influence value above or below a predetermined threshold, etc.). In one example, the influential node may be determined as a node (user) having a large influence spread amongst other nodes (users) within the graph.

It may be appreciated that a chain of nodes may be determined. Influential node pairings comprising the influential node and a node other than the influential node (non-influential node) may be determined based upon the influential node pairing comprising a desired pairing influence value (e.g., a largest influence value, an influence value above or below a predetermined threshold, etc.). In one example, the graph may be reinitialized, such that a new determination of whether edges are activated/deactivated may be performed concurrently on edges within the graph. In this way, new node groupings may be concurrently determined and/or influence values may be assigned. Using the influential node, node parings comprising the influential node and respective non-influential nodes within the graph may be assigned pairing influence values based upon an influence value of the influential node and respective influence values of the non-influential nodes. In one example, if the influential node and the non-influential node are within the same node grouping, then the pairing influence value is the influence value of the non-influential node. If the influential node and the non-influential node are within the different node groupings, then the pairing influence value is the sum of the influence value of the non-influential node and the influence value of the influential node. In this way, an influential node pairing having a desired influential value may be determined. It may be appreciated that an integer value k sized pairings may be determined (e.g., node (A)+node (D)+node (C) as k=3).

In one example of selecting one or more nodes interconnected by edges within a graph, degrees may be assigned to nodes within the graph. A degree of a node may be based upon an edge count of the node. It may be appreciated that in one example of the graph, edges may comprise a substantially uniform influence probability. A first node may be selected based upon the first node having a desired degree (e.g., a largest degree, a degree above or below a predetermined threshold, etc.). The degrees of neighboring nodes of the first node may be discounted based upon a discount value, which may be calculated based upon degrees of the neighboring nodes and/or respective influence probabilities of edges between the first node and the neighboring nodes. A second node different than the first node may be selected based upon the second node having a second desired degree. In this way, degrees of nodes neighboring the second node may be discounted based upon a second discount value. It may be appreciated that an integer value k of nodes may be determined.

In one example of determining a node having a desired influence within a graph comprising nodes interconnected by edges, trees associated with current nodes may be constructed. That is, for respective nodes within the graph, a tree associated with a current node may be constructed. For example, where a graph comprises 4 nodes, 4 trees corresponding to the 4 nodes may be constructed, wherein a tree corresponds to one of the four nodes. The tree may comprise non-current nodes (e.g., the other 3 nodes) and/or influential paths (e.g., maximum influential paths) from non-current nodes to the current node. Edges within the tree may comprise influence probabilities. It may be appreciated that nodes having an undesired influence probability may be excluded from a tree. Additionally, although maximum or shortest influential paths may be referenced herein, it is to be appreciated that other (desired) influential paths could be determined as well. For example, if it is determined that the maximum influential path has some associated (e.g., unanticipated) cost that makes it prohibitive to implement, then some other (lesser) path could be implemented.

For respective trees, path influence probabilities may be assigned to non-current nodes within a tree. For example, a path influence probability of a non-current node may be the multiplication of influence probabilities corresponding to edges within the influential path (e.g., maximum influential path) from the non-current node to the current node of the tree. For respective nodes within the graph, a total path influence probability may be determined based upon respective path influence probabilities (e.g., a graph of 4 nodes may have 4 trees, respective trees having a current node and 3 non-current nodes, thus a node may have a total path influence probability based upon 3 path influence probabilities of trees where the node is not the current node). A first node may be determined based upon the first node having a desired total path influence (e.g., a largest path influence value, a path influence value above or below a predetermined threshold, etc.). In this way, path influence probabilities of nodes within respective trees may be updated based upon path influence probabilities of the first node within respective trees. A second node may be determined based upon the second node having a second desired total influence probability. In this way, path influence probabilities of nodes other than the first node and second node may be updated. It may be appreciated that an integer value k of nodes may be determined.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example of social network data.

FIG. 2 is a flow chart illustrating an exemplary method of assigning influence values to nodes within a graph.

FIG. 3 is a component block diagram illustrating an exemplary system for assigning influence values to nodes within a graph.

FIG. 4 is an illustration of an example of performing N iterations of influence value assignment.

FIG. 5 is an illustration of an example of determining an influential node pairing based upon one or more iterations.

FIG. 6 is a flow chart illustrating an exemplary method of selecting one or more nodes within a graph.

FIG. 7 is a component block diagram illustrating an exemplary system for selecting one or more nodes within a graph.

FIG. 8 is an illustration of an example of selecting a first node and subsequently selecting a second node within a graph.

FIG. 9 is a flow chart illustrating an exemplary method of determining a node having a desired influence within a graph.

FIG. 10 is a component block diagram illustrating an exemplary system for determining a node having a desired influence within a graph.

FIG. 11 is an illustration of an example of determining a total path influence probability for a node B and an example of determining a total path influence probability for a node F.

FIG. 12 is an illustration of an exemplary computer-readable medium wherein processor-executable instructions configured to embody one or more of the provisions set forth herein may be comprised.

FIG. 13 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Social networks have become platforms for people and other entities to disseminate and market information and ideas to a large population in a short period of time. One challenge of effectively disseminating information is finding influential entities (e.g., people, groups, companies, etc.) within a social network in an efficient manner. For example, a company may desire to “spread the word” within a social network about a new product, but may have limited resources to provide incentives for users to endorse the new product. It may be advantageous for the company to select a few influential individuals within the social network, through which to promote the new product. At first, selecting the top individuals having a large amount of user relationships may appear to be a sufficient solution. However, other factors, such as overlap in friend circles between users and groups and/or probabilities that a user would adopt another user's advice may complicate the determination of initial users.

Current techniques, such as current greedy algorithms, a Cost-Effective Lazy Forward scheme, a maximum influential (or other) -path based influence cascade modes, and/or other techniques may be insufficient. For example, one technique may utilize a Monto-Carlo simulation of an influence cascade model to obtain an estimate of an influence spread across a social network. Unfortunately, finding even a relatively small seed set (number of user) within a moderately large social network (e.g., 15,000 vertices) could take days to complete on current server machines. Without modification, current techniques such as current greedy algorithms may be ineffective at finding influence spread across a social network.

Accordingly, one or more systems and/or techniques for determining influences of nodes within a graph are provided herein. In one example, an improved version of a greedy algorithm, which may be coupled with a Lazy-forward scheme, is provided. The improved greedy algorithm may significantly improve running time of the greedy algorithm. In another example, a degree based heuristic technique is provided, which may be capable of selecting nodes within a large social graph (e.g., a graph of a social network comprising billions of nodes). For example, the degree based heuristic may operate with a uniform independent cascade model in which propagation probabilities at edges are similar. In another example, an influential path technique (e.g., a maximum influential path) may be employed with a general independent cascade model where propagation probabilities of edges may be different. The influential path technique may provide quick local updates during execution.

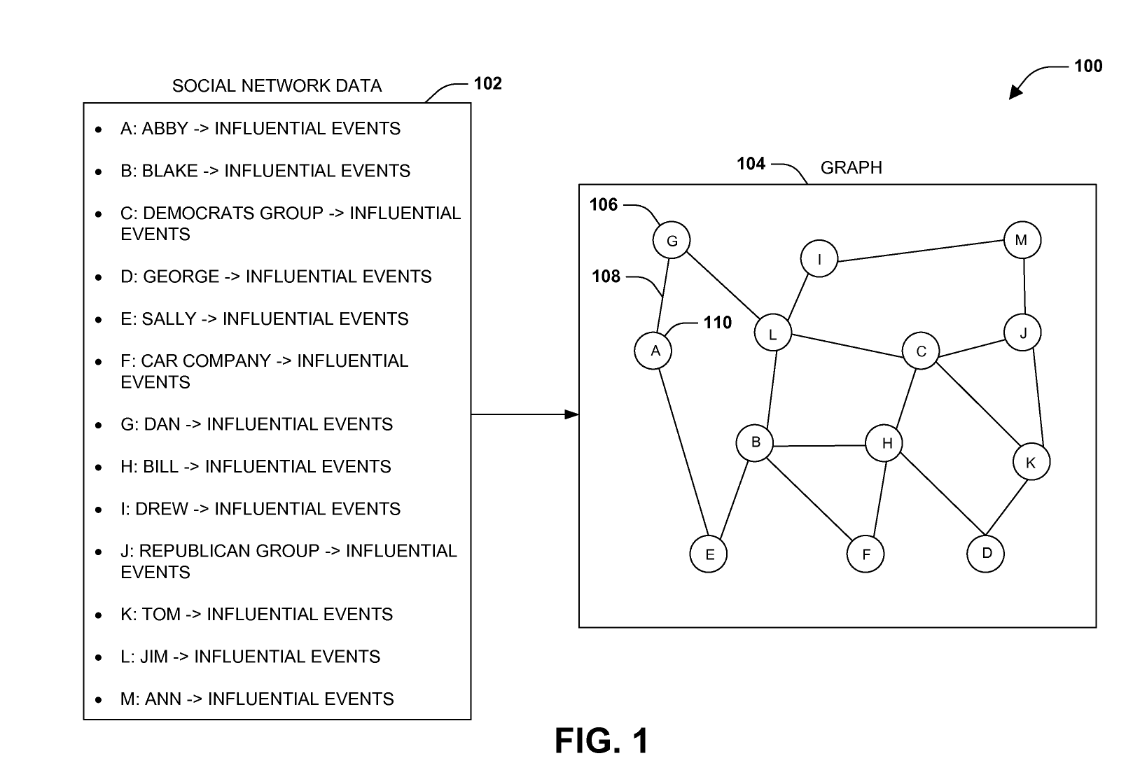

FIG. 1 illustrates an example of social network data 102. The social network data 102 may comprise users within a social network, such as people (e.g., Dan), companies (e.g., Car Company), groups (e.g., Democrats group, Republican group, etc.), and/or other entities. The social network data 102 may comprise influential events associated with the users. For example, an influential event may relate to a suggestion from a first user to second user. The influential event may indicate whether the second user ignored the suggestion, adopted the suggestion, promoted the suggestion, etc. It may be appreciated that the influential events may comprise a variety of data, such as strengths of relationships, friend lists, interests, and/or other user data.

A graph 104 may be generated based upon the social network data 102. The graph may comprise nodes and edges connecting nodes. A node may represent a user. For example, node A 110 may represent Abby, node G 106 may represent Dan, node E may represent Sally, etc. An edge may represent a probability of influence between users (nodes) connected by the edge. The probability of influence may be based upon a variety of user data. For example, an edge 108 between node G 106 and node A 110 may represent a probability of influence that a suggestion between Dan and Abby would influence the other. The probability of influence may be based upon influential data of Dan and Sally within the social network data 102 (e.g., influential events). It may be appreciated that a variety of techniques may be employed to determine one or more users having a large influence spread amongst other users based upon analyzing the graph 104. For example, techniques discussed herein may determine that Ann (node M), Dan (node G 106), and Jim (node L) would have large influence within the social network, such that promoting an idea or product through Ann, Dan, and Jim may reach and/or influence a large number of users within the social network.

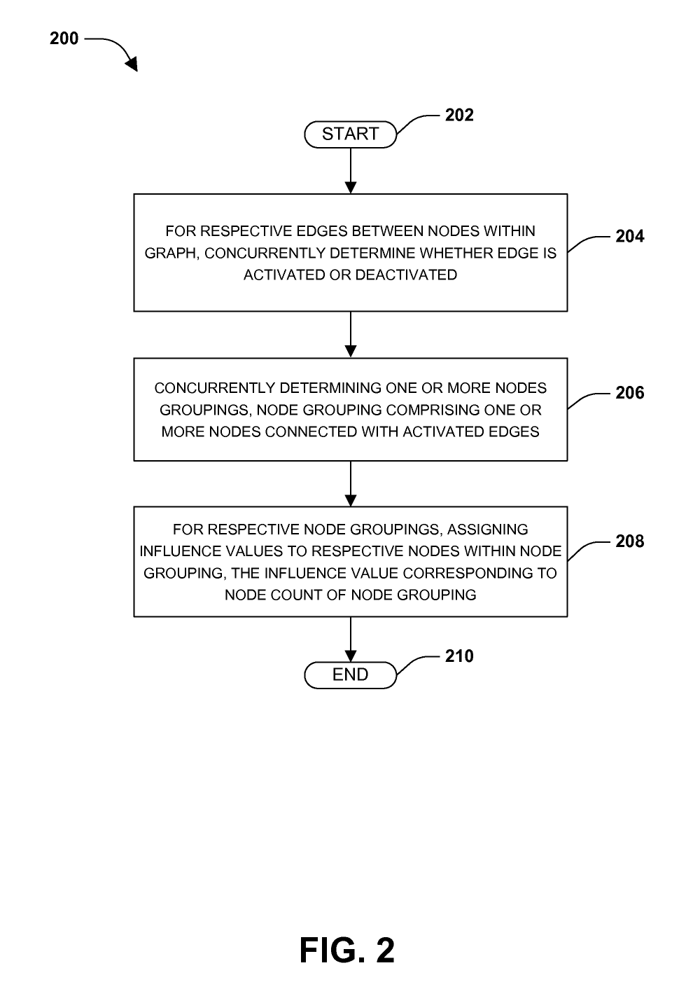

One embodiment of assigning influence values to nodes within a graph is illustrated by an exemplary method 200 in FIG. 2. At 202, the method begins. It may be appreciated that a graph, such as the graph 104 in FIG. 1, may be utilized in assigning influences values to nodes within the graph. Edges within the graph may comprise influence probabilities between node pairings. An influence probability may represent the probability that a user represented by a first node may be influenced by suggestions of another user represented by a second node). It may be appreciated that the graph may be directed or undirected. At 204, for respective edges between nodes within a graph, a determination of whether an edge is activated or deactivated is concurrently performed for edges within the graph. That is, activation/deactivation of edges within the graph are determined in a non-sequential manner (e.g., simultaneously), which may improve speed over current greedy algorithms.

In one example, edge activation/deactivation may be performed using a random function on edges. For example, the random function may denote a random process that randomly determines whether edges are activated and deactivated. It may be appreciated that an activated edge may represent a positive indication that information of a first user represented by a first node may be influenced by a second user represented by a second node, the first node and second node connected by the activated edge. It may be appreciated that a deactivated edge may represent a negative indication that that information of a first user represented by a first node may be influenced by a second user represented by a second node, the first node and second node connected by the activated edge. The random function executed upon an edge may be weighted based upon an influence probability of the edge because the influence probability indicates a likelihood of influence between nodes.

At 206, one or more node groupings may be concurrently determined. That is, node groupings may be determined in a non-sequential order (e.g., simultaneously), which may improve speed. A node grouping may comprise one or more nodes connected by activated edges. In particular, a group of nodes connected by activated edges may be deemed to have a positive indication of influence, and thus the node grouping may indicate that nodes within the node grouping have influence over one another. It may be appreciated that a node grouping may comprise a single node connected to no other nodes.

At 208, for respective node groupings, influence values may be assigned to respective nodes within a node grouping. In one example, the influence value may correspond to a node count of the node grouping. A node count may be a total number of nodes within a node grouping. It may be appreciated that an influence value of a node may indicate how influential the node may be within the graph.

An influential node having a desired influence value may be determined. It may be appreciated that a desired influence value may be a largest influence value, a smallest influence value, an influence value above or below a predetermined threshold, etc. In one example, the influential node may exemplify a user having a desired influence amongst users within a social network modeled by the graph.

It may be appreciated that a chain of users may be determined based upon finding influential node pairings. As a simple example, node B may be determined as the influential node. Using node B, a subsequent iteration of method 200 may be performed to evaluate node pairings between node B and other nodes (e.g., B-A, B-C, B-D, etc.). In this way an influential node pairing may be determined (e.g., B-D is determined as the influential node pairing because B-D has a pairing influence value corresponding to a desired pairing influence value). It may be appreciated that an integer value of chained nodes may be determined. For example, the influential node pairing B-D may be used to evaluate node pairings between B-D and other nodes within the graph (e.g., B-D-A. B-D-M, B-D-C, etc.). In this way, a group of nodes (a chine of users) having desired influence values may be determined.

A node pairing may comprise the influential node and a node other than the influential node (a non-influential node). It may be appreciated that a node pairing may comprise the influential node and one or more other nodes based upon multiple iterations of determining node pairings (e.g., a first iteration may determine an influential node B, a second iteration may determine an influential node pairing B-D, a third iteration may determine an influential node pairing B-D-C). The influential node pairing may be determined based upon a node pairing having a desired pairing influence value. It may be appreciated that a desired pairing influence value may be a largest pairing influence value, a smallest pairing influence value, a pairing influence value above or below a predetermined threshold, etc. In one example, an influential node pairing may be determined based upon reinitializing the graph, determining edge activation/deactivation, determining node groupings, and assigning influence values to nodes within node groupings. In this way, pairing influences values may be assigned to respective node pairings (e.g., influential node B paired with node A, influential node B paired with node C, etc.).

In one example, a pairing influence value may be based at least in part on an influence value of the influential node and/or an influence value of the non-influential node within the node pairing. For example, if a non-influential node is comprised within a node grouping comprising the influential node, then an influence value of the non-influential node may be assigned as the pairing influence value. If the non-influential node is comprised within a node grouping different than a node grouping comprising the influential node, then a sum of the influence values of the non-influential node and the influential node may be assigned as the pairing influence value. It may be appreciated that the influence value of the non-influential node may be the same as the influence value of the influential node because both nodes are within the same node grouping, and thus the influence value of the influential node may be assigned as the pairing influence value. In this way, the influential node pairing may be determined as a node pairing having a pairing influence value corresponding to the desired pairing influence value.

It may be appreciated that because randomness and probability may be involved in determining edge activation/deactivation, a second iteration of method 200 may be performed, which may produce similar or different results for edge activation/deactivation. Likewise, similar or different node groupings may be determined, along with similar or different influence values may be assigned to nodes. In this way, the method 200 may be performed numerous times (e.g., thousands of times) to produce an average influence values for nodes. An influential node may be selected based upon a node having an average influence value corresponding to a desired influence value. At 210, the method ends.

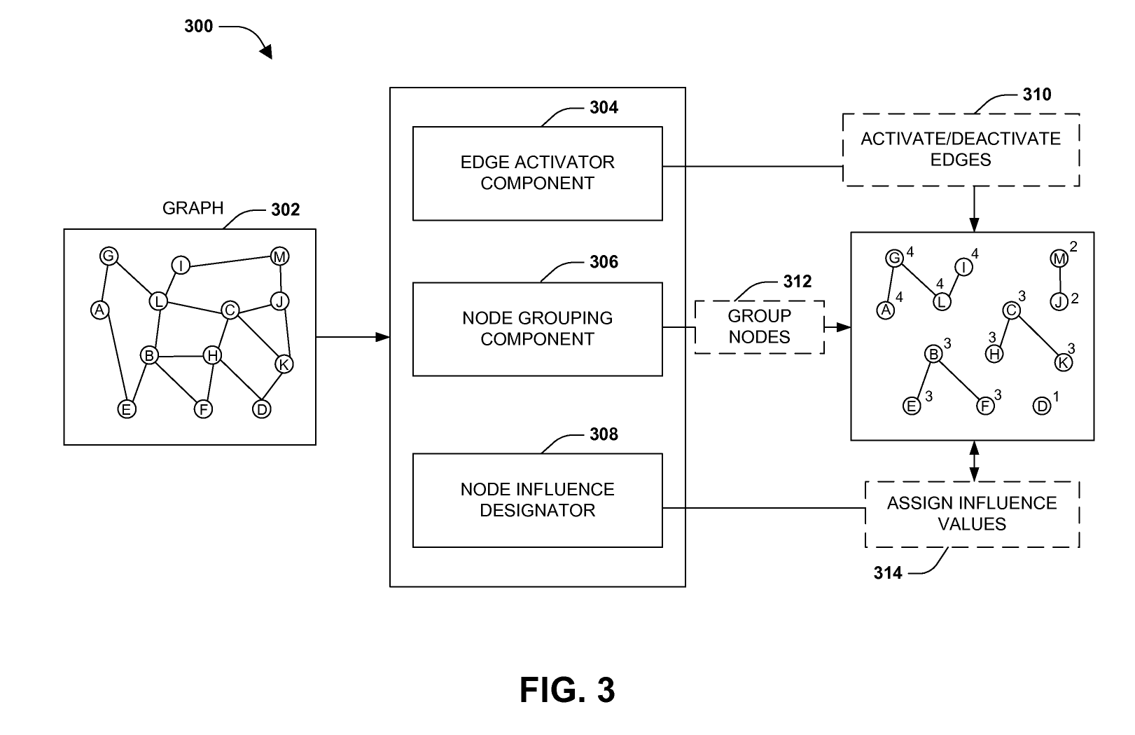

FIG. 3 illustrates an example of a system 300 configured for assigning influence values to nodes within a graph 302. The system 300 may comprise an edge activator component 304, a node grouping component 306, and/or a node influence designator 308. The graph 302 may comprise nodes representing users within a social network and edges comprising weights representing influence probabilities between node pairings (two users).

The edge activator component 304 may be configured determine edge activation 310 of nodes within the graph 302. For example, the edge activator component 304 may concurrently determine whether nodes are activated or deactivated based upon a random function. In one example the random function may be weighted based upon influence probabilities of edges. It may be appreciated that the random function may be weighted similarly or differently for respective edges because influence probabilities may vary in value amongst the edges. In one example, the edge activator component 304 may determine A-G edge, G-L edge, L-I edge, E-B edge, B-F edge, H-C edge, C-K edge, and M-J edge are activated, while other edges within the graph are deactivated.

The node grouping component 306 may be configured to concurrently determine one or more node groupings (group nodes 312). A node grouping may comprise one or more nodes connected with activated edges. For example, a first node grouping may comprise node A, node G, node L, and node I. A second node grouping may comprise node E, node B, and node F. A third node grouping may comprise node D. A fourth node grouping may comprise node H, node C, and node K. A fifth node grouping may comprise node M and node J.

The node influence designator 308 may be configured to assign influence values 314 to nodes within node groupings. An influence value may be based upon a node count of nodes within a node grouping. For example, the node influence designator 308 may assign a node influence value of 4 to nodes A, G, L, and I because the first node grouping comprises 4 nodes. The node influence designator 308 may assign a node influence value of 3 to nodes E, B, and F because the second node grouping comprises 3 nodes. In this way, the node influence designator 308 may assign influence values.

The node influence designator 308 may be configured to determine an influential node having a desired influence value. It may be appreciated that influences values may be assigned to nodes over multiple iterations to generate multiple influence values per node (e.g., method 100 of FIG. 1 may be executed thousands of times). Influence values of nodes may be averaged to determine average influence values. From this, the node influence designator 308 may determine the influential node based upon a node having an average influence value corresponding to a desired influence value.

The system 300 may be configured to determine an integer value of nodes (e.g., an influential node pairing of one or more nodes) based upon an influential node pairing comprising a desired pairing influence value. For example, the node influence designator 308 may be configured to determine pairing influences values for respective nodes pairings, wherein a node pairing comprises an influential node and a non-influential node. It may be appreciated that a node pairing may comprise multiple nodes based upon the number of iterations performed to determine a node pairing comprising an integer value of nodes. In one example, the node influence designator 308 may assign pairing influence values to node pairings based upon whether the influential node and the non-influential node are comprised within the same node grouping. In particular, if a non-influential node is comprised within a node grouping comprising the influential node, then an influence value of the non-influential node may be assigned as the pairing influence value. If the non-influential node is comprised within a node grouping different than a node grouping comprising the influential node, then a sum of the influence values of the non-influential node and the influential node may be assigned as the pairing influence value.

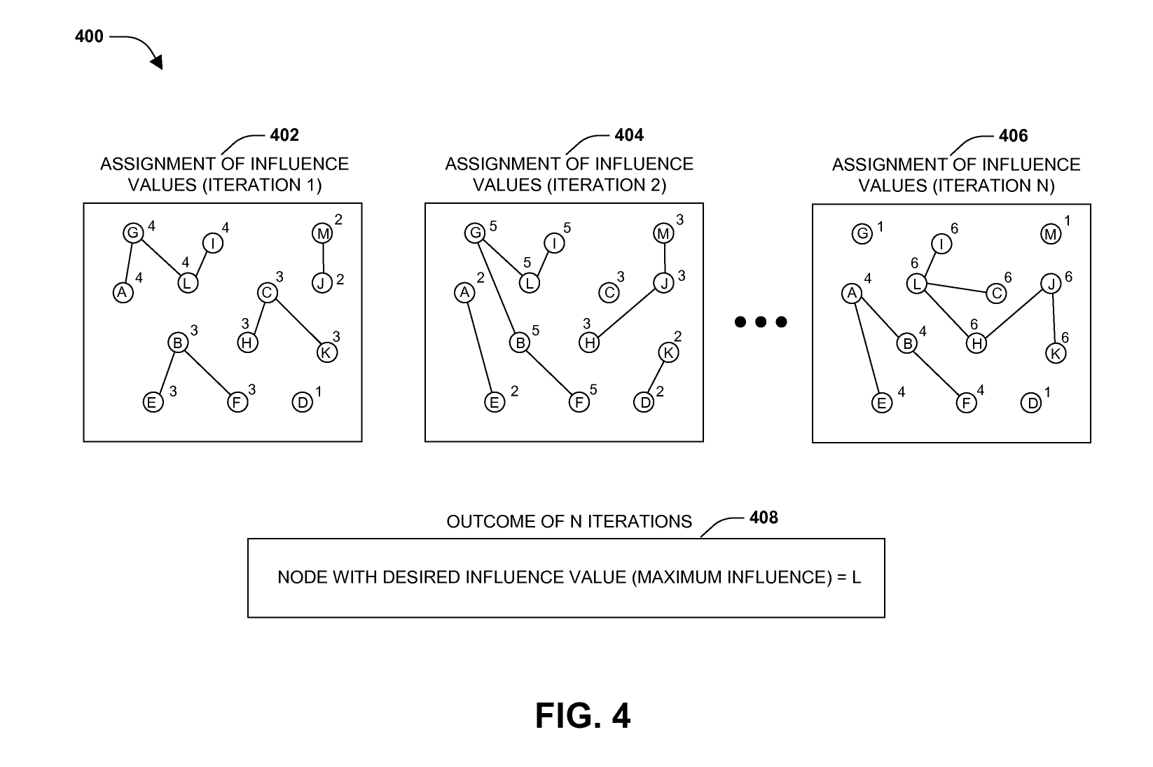

FIG. 4 illustrates an example 400 of performing N iterations of influence value assignment. It may be appreciated that influence values may be assigned according to the method 200 of FIG. 2 and/or the system 300 of FIG. 3. In one example, a first iteration 402 of assigning influence values may be performed. In particular, edge activation/deactivation may be determined. For example, A-G edge, G-L edge, L-I edge, E-B edge, B-F edge, H-C edge, C-K edge, and M-J edge may be determined as activated, while other edges are determined as deactivated. Node groupings may be determined from nodes connected with activated edges. For example, a first node grouping may comprise node A, node G, node L, and node I. A second node grouping may comprise node E, node B, and node F. A third node grouping may comprise node D. A fourth node grouping may comprise node H, node C, and node K. A fifth node grouping may comprise node M and node J.

Influence values may be assigned to nodes within node groupings based upon a node count within the node groupings. For example, a node influence value of 4 may be assigned to nodes A, G, L, and I because the first node grouping comprises 4 nodes. A node influence value of 3 may be assigned to nodes E, B, and F because the second node grouping comprises 3 nodes. In this way, influence values may be assigned to nodes. It may be appreciated that influences values assigned to nodes during an iteration may be stored. In iteration 1, nodes A, G, L, and I may be determined as influential nodes because their respective influence value of 4 may correspond to a desired influence value.

A second iteration 404 may be performed. In one example, the graph may be reinitialized, such that the graph is in an original state before previous iterations. During the second iteration 404, edge activation/deactivation may be determined. Node groupings may be determined from nodes connected with activated edges. Influence values may be assigned to nodes within node groupings. In one example, nodes F, B, G, L, and I may be determined as influential nodes because nodes F, B, G, L, and I may be assigned influence values of 5, which may correspond to a desired influence value. In another example, the nodes and influence values may be stored so that influences values of the second iteration 404 may be averaged with influences values assigned during other iterations.

It may be appreciated that N iterations 406 may be performed. In one example, influence values from respective iterations may be averaged to create average influence values for respective nodes, which may be used to determine an “overall” influential node. In another example, nodes determined as influential nodes during respective iterations may be evaluated to determine the “overall” influential node. It may be appreciated that a variety of techniques may be used to determine an influential node based upon the data generated by the iterations. Based upon the outcome of the N iterations 408, node L may be determined as the influential node having a desired influence value (e.g., a largest influence value). In particular node L may have a largest average influence value over the N iterations (e.g., an average influence value based upon influence values of 4 from iteration 1, 5 from iterations 2 . . . and 6 from iterations N).

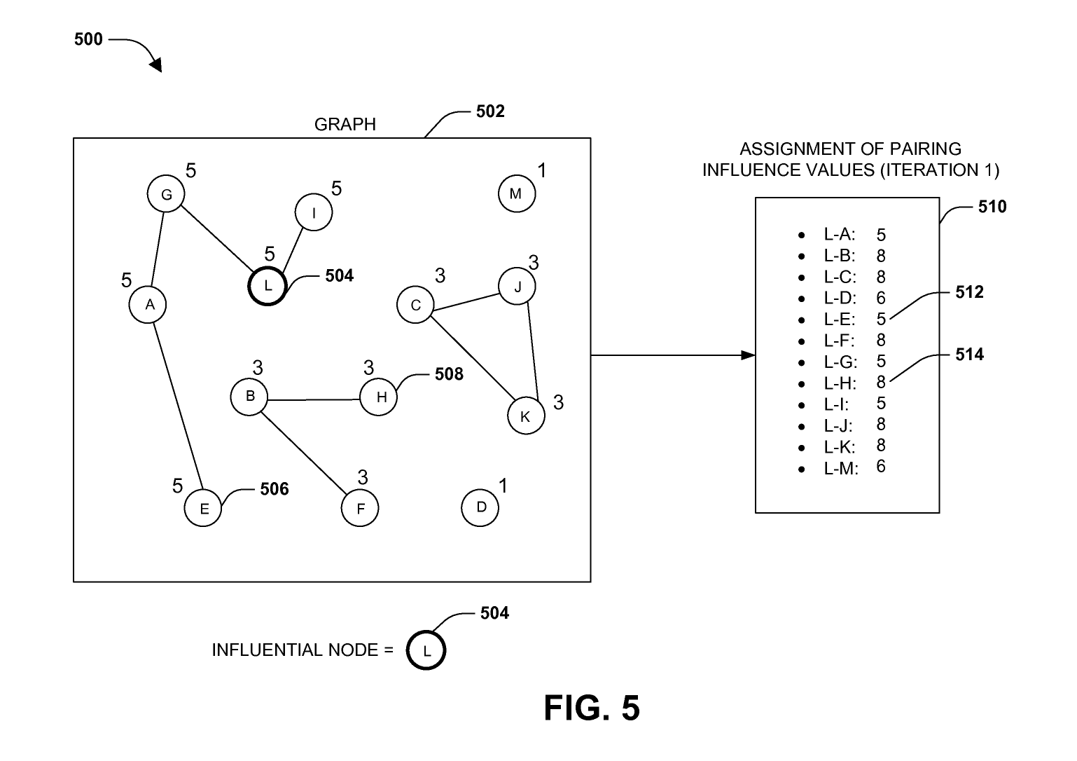

FIG. 5 illustrates an example 500 of determining an influential node pairing based upon one or more iterations. It may be appreciated that pair influence values may be assigned to node pairings during a single iteration (e.g., iteration (1) 510). However, multiple iterations may be performed to generate multiple pair influences values for a node pairing (e.g., L-A node pairing may have five hundred pair influences values based upon an iteration of 500). In this way, an influential node pairing may be determined based upon an average of pair influence values assigned to the influential node pairing during multiple iterations.

In one example, a graph 502 may comprise nodes (e.g., an influential node L 504, node E 506, node H 508, etc.) interconnected by edges. It may be appreciated that the influential node L 504 may have been determined using the method 200 of FIG. 2 and/or the system 300 of FIG. 3. Upon determining the influential node L 504, the graph 502 may be reinitialized into an original state. Edge activation/deactivation may be concurrently determined for edges within the graph 502. Node groupings may be determined based upon nodes connected with activated edges. Influence values may be assigned to nodes. It may be appreciated that the graph 502 is illustrated at a state where edge activation/deactivation, node groupings, and/or influence values have already been assigned when the graph was reinitialized after determining the influential node L 504.

Pairing influence values may be assigned to node pairings within the graph 502. In one example, node pairings L-A, L-B, L-C, L-D . . . L-M may be assigned pairing influence values corresponding to an influence value of the influential node L 504 and influences values of non-influential nodes. In particular, if a non-influential node is comprised within a node grouping comprising the influential node L 504, then an influence value of the non-influential node may be assigned as the pairing influence value (e.g., node pairings L-I, L-G, L-A, and L-E). If the non-influential node is comprised within a node grouping different than a node grouping comprising the influential node L 504, then a sum of the influence values of the non-influential node and the influential node is assigned as the pairing influence value (e.g., node pairings L-B, L-H, L-F, L-D, L-C, L-J, L-K, and L-M).

For example, the node pairing L-E may be assigned a pairing influence value 512 of 5 because the influential node L 504 and the non-influential node E 506 are comprised in the same node grouping with 5 nodes. The pairing influence value 512 reflects the notion that influential node L 504 and the non-influential node E 506 may have overlapping influence (e.g., nodes G, A, and I). The node pairing L-H may be assigned a pairing influence value 514 of 8 because the influential node L 504 and the non-influential node H 508 are comprised in different nodes groups. The pairing influence value 514 reflects the notion that the influential node L 504 and the non-influential node H 508 may influence different nodes in different node groups.

It may be appreciated that an integer value of nodes may be determined (e.g., a 5 node chain may comprise the sequence L-B-D-E-M). Once an influential node pairing is determined (e.g., L-B), then the influential node pairing L-B may be interpreted as an influential node for the next iteration of determining of an influential node pairing. That is, L-B may be used as the influential node, and node pairings may comprise L-B-C, L-B-D, L-B-F, etc. In this way, the next influential node pairing may be determined (e.g., L-B-D). The next influential node pairing L-B-D may be used as the influential node for the next determination of the next influential node pairing. That is, L-B-D may be used as the influential node, and node pairings may comprise L-B-D-C, L-B-D-F, L-B-D-M, etc. In this way, the next influential node pairing may be determined (e.g., L-B-D-E).

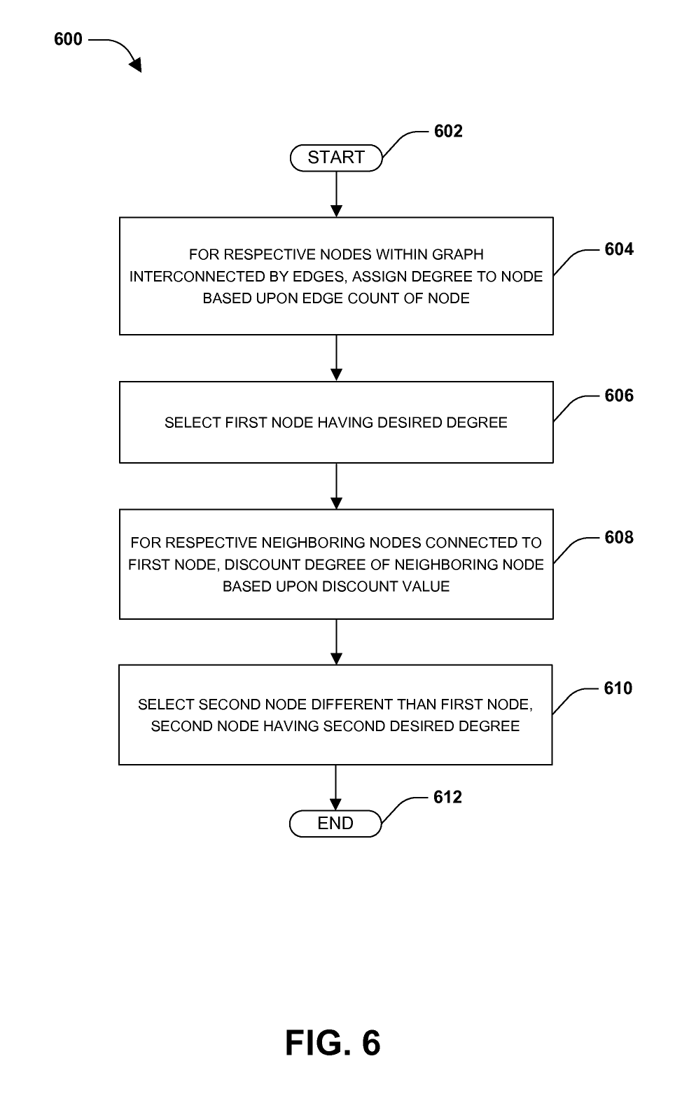

One embodiment of selecting one or more nodes within a graph is illustrated by an exemplary method 600 in FIG. 6. At 202, the method begins. It may be appreciated that a graph, such as the graph 104 in FIG. 1, may be utilized in selecting one or more nodes within the graph. Edges within the graph may comprise influence probabilities between node pairings (e.g., the probability that a user represented by a first node may be influenced by information of another user represented by a second node). In one example, the edges within the graph may comprise substantially uniform influence probabilities. It may be appreciated that the graph may be directed or undirected.

At 604, for respective nodes within a graph interconnected by edges, a degree may be assigned to a node based upon an edge count of the node. That is, a degree may correspond to a number of edges connected to a node. Thus, a node L connected to a node G, a node I, a node B, and a node C would be assigned a degree of 4. At 606, a first node having a desired degree may be selected. It may be appreciated that a desired degree may be largest degree value, a smallest degree value, a degree value above or below a predetermined threshold, etc. The first node may be selected based upon a desired degree because the degree of the first node may reflect the notion that the first node has a high probability of influence amongst other nodes within the graph. It may be appreciated that in one example, neighboring nodes of the first node may be interpreted as nodes directly connected to the first node by a single edge.

At 608, for respective neighboring nodes connected to the first node, a degree of a neighboring node may be discounted based upon a discount value for the neighboring node. A discount value may be calculated based upon at least one: a degree of the neighboring node, degrees of respective neighboring nodes, influence probabilities of edges between the first node and the neighboring nodes, and/or other criteria. In one example, a single discount value may be applied to respective neighboring nodes. In another example, different discount values may be applied to different neighboring nodes. The neighboring nodes may be discounted in order to take into account that the first node was selected.

At 610, a second node different than the first node may be selected based upon the second node having a second desired degree. It may be appreciated that the second desired degree may be the same or different than the first desired degree. For respective neighboring nodes connected to the second node, a degree of a neighboring node may be discounted based upon a second discount value. It may be appreciated that the second discount value may be the same or different than the first discount value. In this way, an integer value of nodes may be selected within the graph. At 612, the method ends.

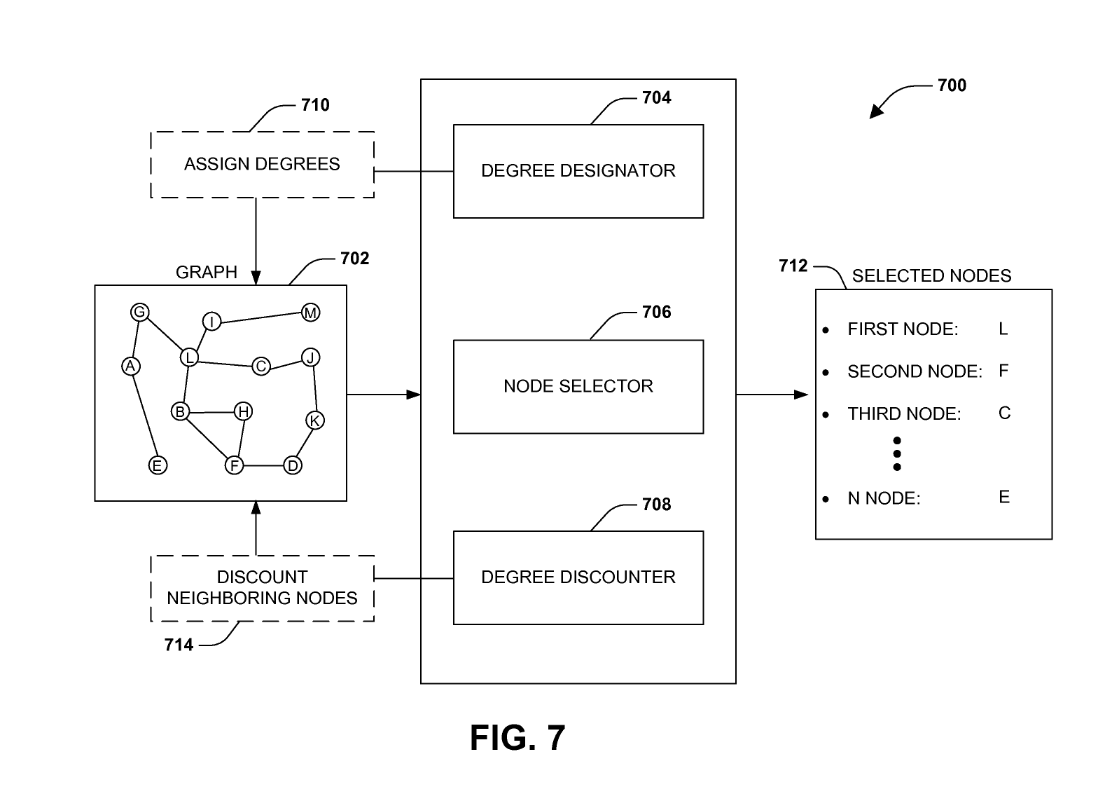

FIG. 7 illustrates an example of a system 700 configured for selecting one or more nodes within a graph 702. The system 700 may comprise a degree designator 704, a node selector 706, and/or a degree discounter 708. The graph 702 may comprise nodes and edges connecting node pairings. The degree designator 704 may be configured to assign degrees 710 to nodes within the graph 702. A degree may be assigned to a node based upon an edge count of the node. For example, node L may be assigned 4, node C may be assigned 2, node F may be assigned 3, node M may be assigned 1, etc.

In one example, the node selector 706 may be configured to select a first node having a desired degree. The node selector 706 may select node L as the first node because node L has a degree of 4 (e.g., a largest degree). Based upon the selection of first node L, the degree discounter 708 may be configured to discount degrees of first node L's neighboring nodes. For example, node G, node I, node C, and/or node B may be discounted with discount values. The degree discounter 708 may be configured to calculate discount values based upon at least one of: a degree of the neighboring node, degrees of respective neighboring nodes, influence probabilities of edges between the first node and the neighboring nodes, and/or other criteria.

The node selector 706 may be configured to select a second node different than the first node L based upon the second node having a second desired degree. For example, the node selector 706 may select node F as the second node because node F has a degree of 3 (e.g., the largest degree excluding). In particular, node F may have a higher degree than node B because node B's degree may have been discounted based upon node L being selected as the first node. Based upon the selection of second node F, the degree discounter 708 may be configured to discount degrees of second node F's neighboring nodes. For example, node B, node H, and/or node D may be discounted with second discount values. In this way, one or more nodes may be selected, which may reflect nodes having a desired influence within the graph 702. It may be appreciated that the node selector 706 may be configured to select an integer value of nodes to create the selected group of nodes 712.

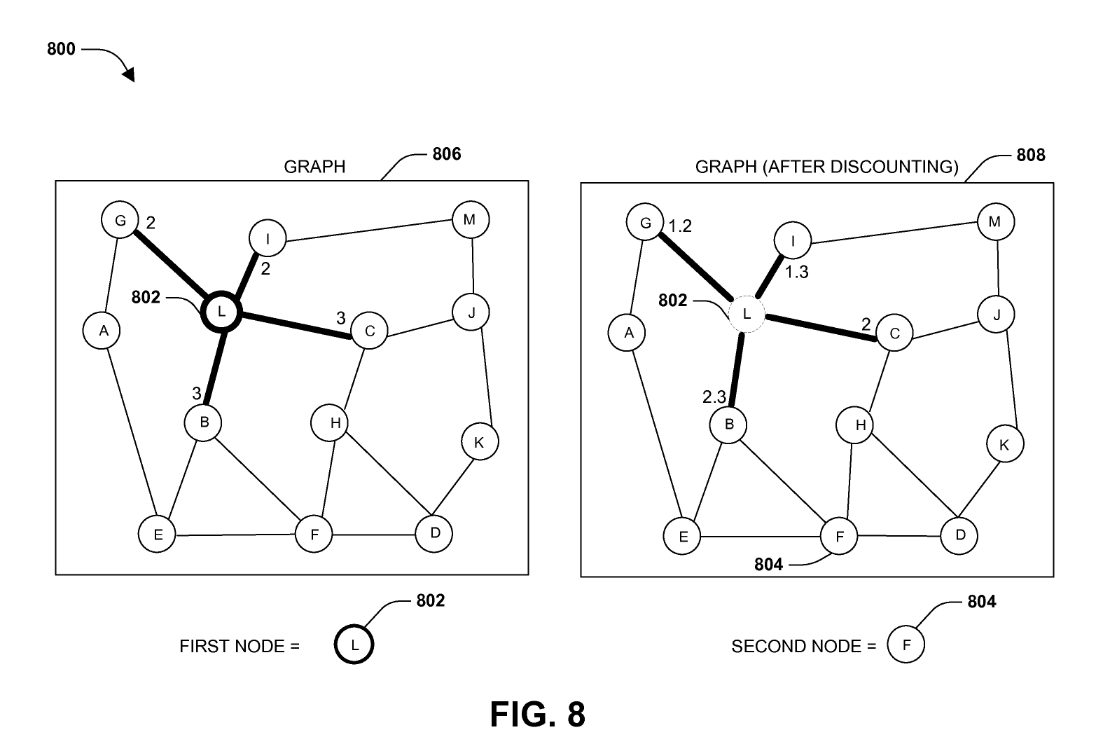

FIG. 8 illustrates an example 800 of selecting a first node (and subsequently selecting a second node within a graph 806. In one example, the graph 806 may comprise nodes interconnected by edges. Degrees may be assigned to nodes based upon edge counts of respective nodes (e.g., nodes G has a degree of 2, node A has a degree of 2, node L has a degree of 4, node I has a degree of 2, node C has a degree of 3, etc.). Node L may be selected as a first node (first node L 802) because node L's degree of 4 may correspond to a desired degree (e.g., a largest degree). Degrees of neighboring nodes of first node L 802 may be discounted based upon discount values. For example, node G may be discounted by 0.8, node I may be discounted by 0.7, node B may be discounted by 0.7, and node 2 may be discounted by 1. In this way, node G has a discounted degree of 1.2, node I has a discounted degree of 1.3, node B has a discounted degree of 2.3, and node C has a discounted degree of 2. The graph after discounting 808 illustrates the graph 806 after neighboring nodes are discounted.

A second node different than the first node L 802 may be selected based upon the second node having a second discounted value. For example, node F may be selected as the second node (second node F 804) because node F's degree of 4 may correspond to a second desired degree (e.g., a largest degree). Degrees of neighboring nodes of second node F 804 may be discounted by second discount values. For example, degrees of nodes B, H, D, and E may be discounted by second discount values. In this way, an integer value of nodes may be selected, which may reflect nodes having a desired influence within the graph 806. In one example, a node may be selected just once to avoid redundancy.

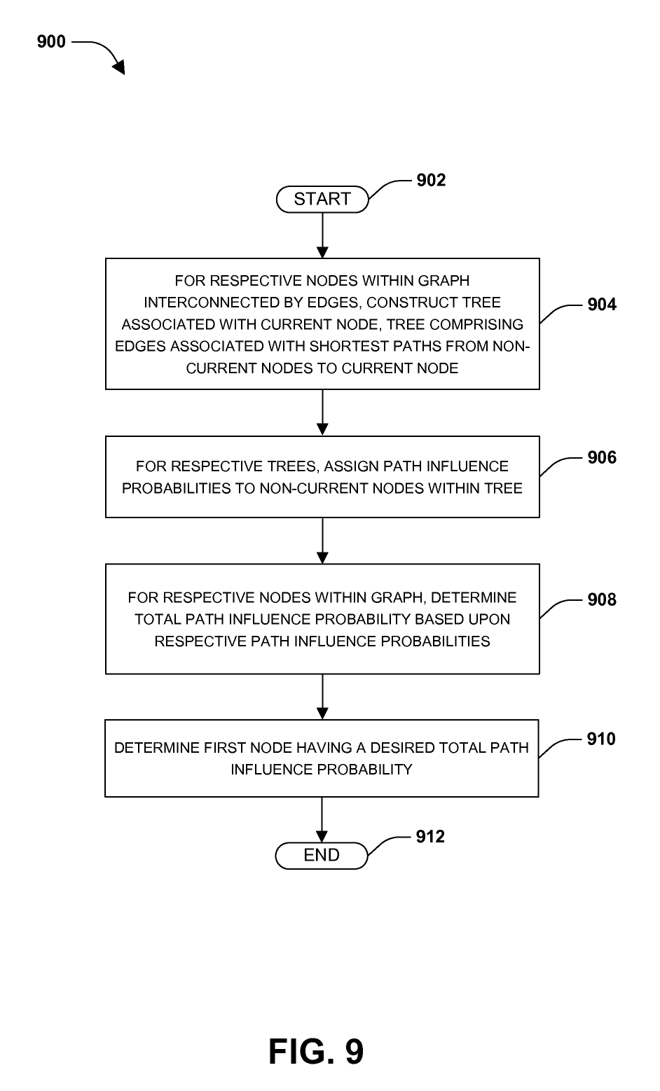

One embodiment of determining a node having a desired influence within a graph is illustrated by an exemplary method 900 in FIG. 9. At 902, the method begins. It may be appreciated that a graph, such as the graph 104 in FIG. 1, may be utilized in determining one or more nodes having desired influence within the graph. Edges within the graph may comprise influence probabilities between nodes pairings (e.g., the probability that a user represented by a first node may be influenced by information of another user represented by a second node).

At 904, for respective nodes (e.g., node A, node B, node C, and node D) within a graph interconnected by edges, a tree associated with a current node may be constructed (e.g., tree A, tree B, tree C, and tree D). A tree may comprise edges associated with influential paths (e.g., maximum influential paths) from non-current nodes to a current node of the tree. As a simple example, a graph may comprise 4 nodes A, B, C, and D. Tree A may be constructed for node A, where node A is the current node and nodes B, C, and D are non-current nodes. Tree A may comprise maximum influential paths from node B to A, node C to A, and node D to A. Tree B may be constructed for node B, where node B is the current node and nodes A, C, and D are non-current nodes. Tree B may comprise maximum influential paths from node A to B, node C to B, and node D to B. Tree C may be constructed for node C, where node C is the current node and nodes A, B, and D are non-current nodes. Tree C may comprise maximum influential paths from node A to C, node B to C, and node D to C. Tree D may be constructed for node D, where node D is the current node and nodes A, B, and C are non-current nodes. Tree D may comprise maximum influential paths from node A to D, node B to D, and node C to D. In one example, non-current nodes having an undesired influence probability (e.g., a low influence probability or a long maximum influential path) may be excluded from a tree.

Edges within the “original” graph may comprise influence probabilities. A negative logarithmic may be taken of an influence probability of an edge to determine a weight of the edge. Weights of edges may be used to determine influential paths (e.g., maximum or shortest influential paths) from a non-current node to a current node. In one example, a maximum influential path from a non-current node to a current node may be determined based upon multiplying weights of edges along a path from the non-current node to the current node. For example, a Dijkstra algorithm may be used to calculate the maximum influential paths. In this way, a tree comprising a current node, one or more non-current nodes, and maximum influential paths from respective non-current nodes to the current node may be calculated in order to build the tree corresponding to the current node.

At 906, for respective trees (e.g., tree A, tree B, tree C, and tree D), path influence probabilities may be assigned to non-current nodes within a tree. In particular, for respective non-current nodes (e.g., node B, node C, and node D of tree A), a path influence probability may be calculate for a non-current node (e.g., node C) to the current node (e.g., node A) based upon one or more influence probabilities of edges connecting the non-current node to the current node within the tree (e.g., edge of a maximum influential path from node C to node A). In one example, influence probabilities of edges from the non-current node to the current node may be multiplied to calculate a path influence probability.

In one example, a path influence probability may be assigned to node C within tree A based upon influence probabilities of edges connecting node C to node A within tree A. In another example, a path influence probability may be assigned to node D within tree C based upon influence probabilities of edges connecting node D to node C within tree C. In this way, non-current nodes within respective trees may be assigned path influence probabilities. For example, node B, C, and D in tree A are assigned path influence probabilities; nodes A, C, and D in tree B are assigned path influence probabilities; nodes A, B, and D in tree C are assigned path influence probabilities; and nodes A, B, and C in tree D are assigned path influence probabilities.

At 908, for respective nodes within the graph (e.g., nodes A, B, C, and D), determine a total path influence probability for a node based upon respective path influence probabilities of the node. In one example, a total path influence probability for node A may be determined based upon a path influence probability of node A within tree B, a path influence probability of node A within tree C, and a path influence probability of node A within tree D. In this way, total path influence probabilities may be assigned to nodes A, B, C, and D. At 910, a first node having a desired total path influence probability may be determined. It may be appreciated that a desired total path influence probability may be a largest influence value, a smallest influence value, an influence value above or below a predetermined threshold, etc. For example, node B may have the largest total path influence probability and may be selected as the first node because node B may have a largest influence upon other nodes within the graph.

Path influence probabilities of nodes within respective trees may be updated based upon the selection of the first node. That is, influence probabilities of nodes other than the first node may be updated based upon the path influence probabilities of the first node within respective trees. For example, if node B is selected as the first node, then path influence probabilities of: nodes A, C, and D in tree A may be adjusted based upon node B's path influence probability within tree A; nodes A, C, and D in tree B may be adjusted based upon node B's path influence probability within tree B; nodes A, C, and D in tree C may be adjusted based upon node B's path influence probability within tree C; and/or nodes A, C, and D in tree D may be adjusted based upon node B's path influence probability within tree D. Upon selecting the first node and updating path influence probabilities, a second node having a second desired total influence path probability may be determined. This is way, one or more nodes having desired influence within the graph may be determined. At 912, the method ends.

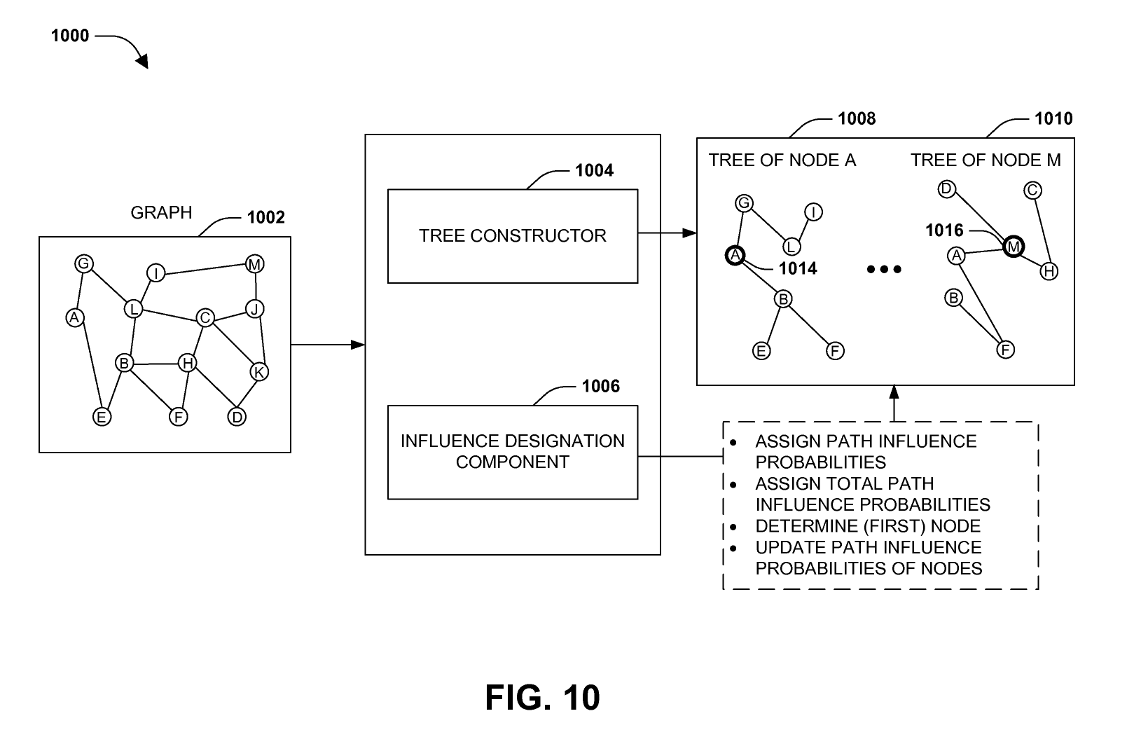

FIG. 10 illustrates an example of a system 1000 configured for determining a node having a desired influence within a graph 1002 interconnected by edges. The system 1000 may comprise a tree constructor 1004 and/or an influence designation component 1006. The graph 1002 may comprise nodes and edges comprising influence probabilities between nodes pairings. The tree constructor 1004 may be configured to construct trees corresponding to nodes within the graph 1002. It may be appreciated that a tree may comprise edges associated with influential paths (e.g., maximum influential paths) from non-current nodes to a current node within a tree. For example, the tree constructor 1004 may construct a tree A 1008 for current node A 1014, a tree M 1010 for current node M 1016, and/or other trees for respective nodes within the graph 1002. It may be appreciated that a tree may comprise a current node, one or more non-current nodes, and influential paths (e.g., maximum influential paths) from non-current nodes to the current node. For example, tree A 1008 may comprise current node A 1014, non-current nodes G, L, I, B, E, and F, and maximum influential paths from non-current nodes to the current node A 1014. In one example, a maximum influential path from non-current node F to current node A 1014 within tree A 1008 may be determined based upon multiplying a weight (the negative logarithmic of influence probabilities of edges) of an edge between non-current nodes F and B with a weight of an edge between a non-current node B and the current node A 1014. It may be appreciated that a Dijkstra algorithm may be used to calculate maximum influential paths.

The influence designation component 1006 may be configured to assign path influence probabilities to non-current nodes within respective trees. For example, the influence designation component 1006 may assign path influence probabilities to non-current nodes G, L, I, B, E, and F within tree A based upon influence probabilities of edges connecting respective non-current nodes to the current node A 1014. The influence designation component 1006 may be configured to assign total path influence probabilities to nodes within the graph 1002 (e.g., nodes A, G, E, B, L, I, F, H, D, K, C, J, and M). For example, a total path influence probability may be assigned to node M based upon path influence probabilities of node M within trees where node M is a non-current node (e.g., tree A through tree L).

The influence designation component 1006 may be configured to determine a first node having a desired total path influence probability. The influence designation component 1006 may be configured to update path influence probabilities of nodes other than the first node with respective trees based upon path influence probabilities of the first node within respective trees. In one example, if node A is determined as the first node, then influence values of nodes B through M may be updated within tree A 1008 through tree M 1010. For example, the influence probability of node A within tree M 1010 may be used to update influence probabilities of nodes B through M within tree M 1010. The influence probability of node A within tree C may be used to update influence probabilities of nodes B through M within tree C. In this way, influence probabilities of nodes other than first node A may be updated within respective trees. The influence designation component 1006 may be configured to select a second node having a second desired total influence probability. It may be appreciated that influence probabilities of nodes other than the second node within respective trees may be based upon the determination of the second node. In this way, one or more nodes having desired influence within the graph 1002 may be determined.

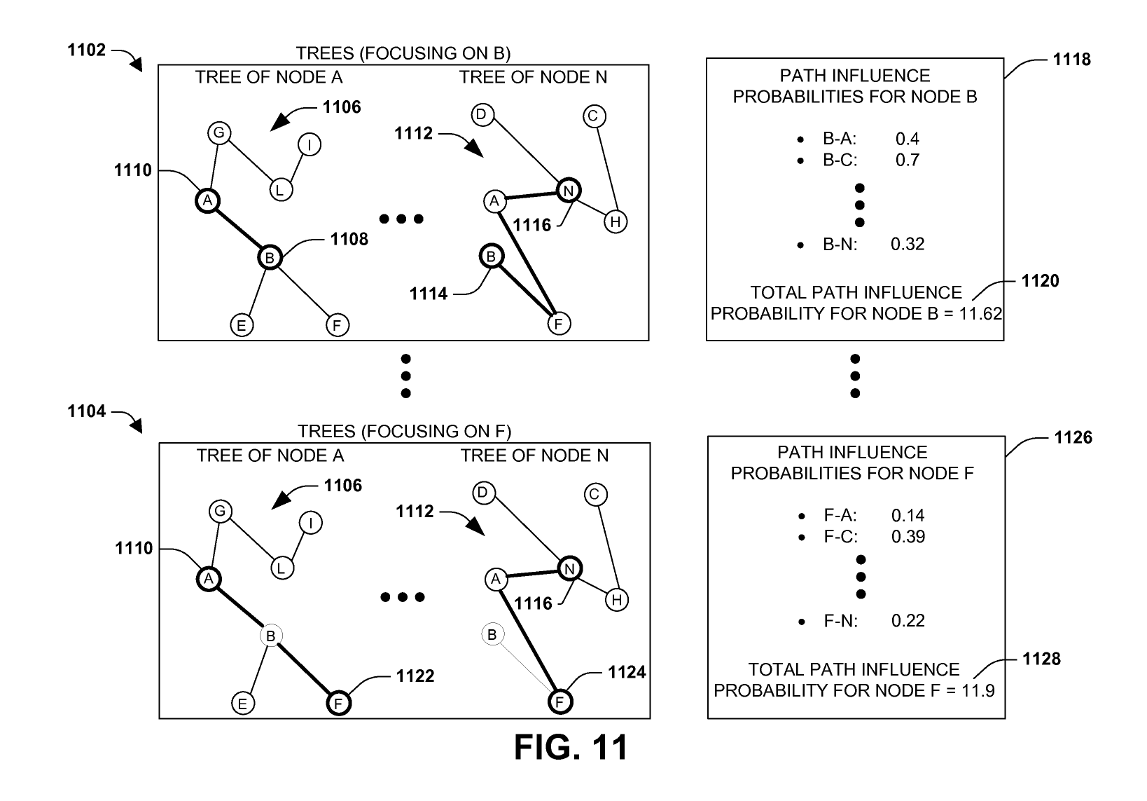

FIG. 11 illustrates an example 1102 of determining a total path influence probability for node B 1120 and an example 1104 of determining a total path influence probability for node F 1128. Example 1102 may comprise trees associated with current nodes of a graph (e.g., tree of node A 1106, tree of node B, tree of node C . . . tree of node N 1112). A tree (e.g., tree N 1112) may comprise a current node (e.g., current node N 1116), non-current nodes (e.g., non-current nodes D, C, H, A, F, and B), and maximum influential paths between respective non-current nodes and the current node. In one example, a maximum influential path for non-current node B 1114 within tree of node N 1112 would comprise edge B to F, edge F to A, and edge A to N.

In example 1102, a total path influence probability for node B 1120 may be determined. In particular, path influences probabilities for node B 1118 within trees where node B is a non-current node may be determine. In one example, a path influence probability of 0.4 between non-current node B 1108 and current node A 1110 (B-A) may be determined for non-current node B 1108 based upon influence probabilities of edges along the maximum influential path between non-current node B 1108 and current node A 1110 within tree of node A 1106 (B-A). The maximum influential path from non-current node B 1108 to current node A 1110 within tree of node A 1106 is edge B to A, which may have an influence value of 0.4, for example.

In another example, a path influence probability of 0.32 between non-current node B 1114 and current node N 1116 (B-N) may be determined for non-current node B 1114 based upon influence probabilities of edges along the maximum influential path between non-current node B 1114 and current node N 1116 within tree of node N 1112 (B-N). The maximum influential path from non-current node B 1114 to current node N 1116 within tree of node N 1112 is edge B to F, edge F to A, and edge A to N. In one example, the path influence probabilities may be based upon the multiplication of edge B to F, edge F to A, and edge A to N. It may be appreciated that a variety of techniques for calculating the path influence value are contemplated as falling within the scope of the claimed subject matter. In this way, path influence probabilities for node B 1118 may be determined. The total path influence probability for node B 1120 (14.62) may be the sum of the path influence probabilities for node B (e.g., 0.4, 0.7 . . . 0.32) within respective trees.

In example 1104, a total path influence probability for node F 1128 may be determined. In particular, path influences values for node F within respective trees where node F is a non-current node may be determined (e.g., trees A through E and trees F through N). In one example, a path influence probability of 14 between non-current node F 1122 and current node A 1110 (F-A) may be determined for non-current node F 1122 based upon influence probabilities of edges along the maximum influential path between non-current node F 1122 and current node A 1110 within tree of node A 1106. The maximum influential path from non-current node F 1122 to current node A 1110 within tree of node A 1106 is edge F to B, and edge B to A. In another example, a path influence probability of 0.39 between non-current node F 1124 and current node N 1116 (F-N) may be determined for non-current node F 1124 based upon influence probabilities of edges along the maximum influential path between non-current node F 1124 and current node N 1116 within tree of node N 1112. The maximum influential path from non-current node F 1124 to current node N 1116 within tree of node N 1112 is edge F to A and edge A to N. In this way, path influence probabilities for node F 1126 may be determined. The total path influence probability for node F 1128 (11.9) may be the sum of the path influence probabilities for node F (e.g., 0.14, 0.39 . . . 0.22) within respective trees. In this way, a first node may be selected based upon a node having a desired total path influence probability.

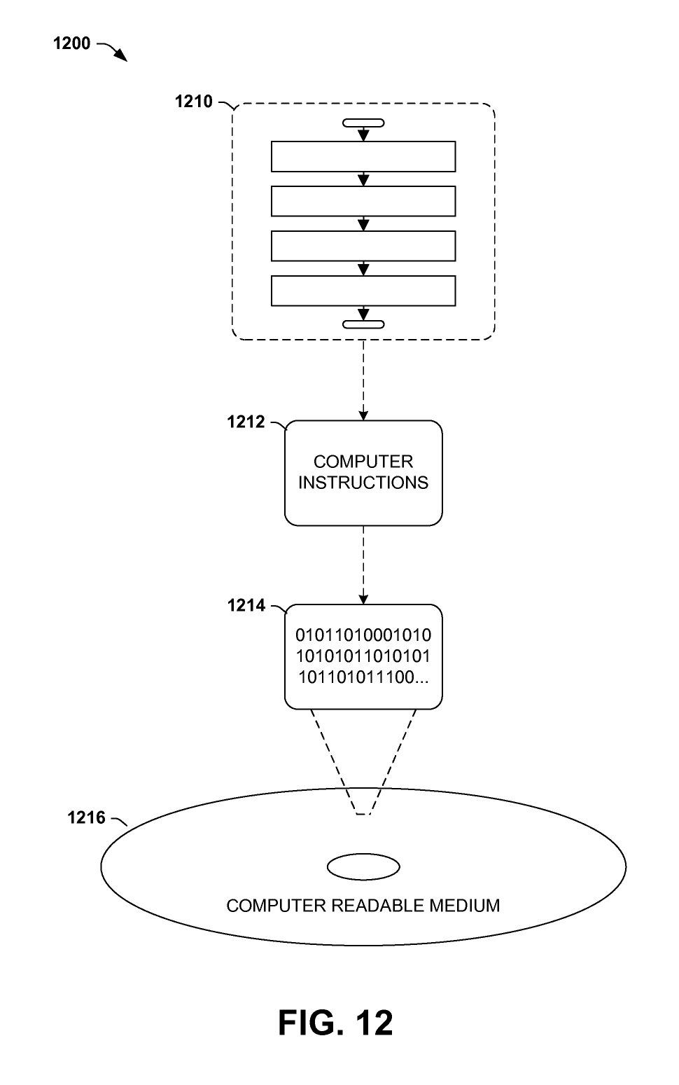

Still another embodiment involves a computer-readable medium comprising processor-executable instructions configured to implement one or more of the techniques presented herein. An exemplary computer-readable medium that may be devised in these ways is illustrated in FIG. 12, wherein the implementation 1200 comprises a computer-readable medium 1216 (e.g., a CD-R, DVD-R, or a platter of a hard disk drive), on which is encoded computer-readable data 1214. This computer-readable data 1214 in turn comprises a set of computer instructions 1212 configured to operate according to one or more of the principles set forth herein. In one such embodiment 1200, the processor-executable computer instructions 1212 may be configured to perform a method 1210, such as the exemplary method 200 of FIG. 2, exemplary method 600 of FIG. 6, and/or exemplary method 900 of FIG. 9, for example. In another such embodiment, the processor-executable instructions 1212 may be configured to implement a system, such as the exemplary system 300 of FIG. 3, exemplary method 700 of FIG. 7, and/or exemplary method 1000 of FIG. 10, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

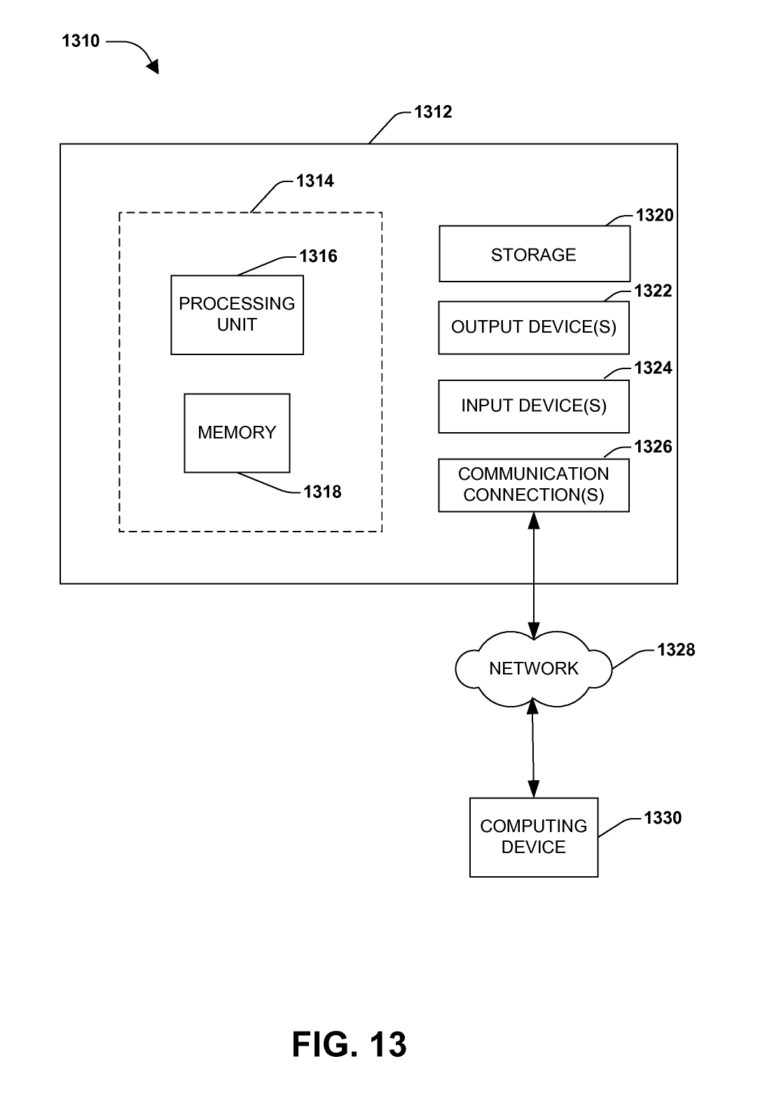

FIG. 13 and the following discussion provide a brief, general description of a suitable computing environment to implement embodiments of one or more of the provisions set forth herein. The operating environment of FIG. 13 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 13 illustrates an example of a system 1310 comprising a computing device 1312 configured to implement one or more embodiments provided herein. In one configuration, computing device 1312 includes at least one processing unit 1316 and memory 1318. Depending on the exact configuration and type of computing device, memory 1318 may be volatile (such as RAM, for example), non-volatile (such as ROM, flash memory, etc., for example) or some combination of the two. This configuration is illustrated in FIG. 13 by dashed line 1314.

In other embodiments, device 1312 may include additional features and/or functionality. For example, device 1312 may also include additional storage (e.g., removable and/or non-removable) including, but not limited to, magnetic storage, optical storage, and the like. Such additional storage is illustrated in FIG. 13 by storage 1320. In one embodiment, computer readable instructions to implement one or more embodiments provided herein may be in storage 1320. Storage 1320 may also store other computer readable instructions to implement an operating system, an application program, and the like. Computer readable instructions may be loaded in memory 1318 for execution by processing unit 1316, for example.

The term “computer readable media” as used herein includes computer storage media. Computer storage media includes volatile and nonvolatile, removable and non-removable media implemented in any method or technology for storage of information such as computer readable instructions or other data. Memory 1318 and storage 1320 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1312. Any such computer storage media may be part of device 1312.

Device 1312 may also include communication connection(s) 1326 that allows device 1312 to communicate with other devices. Communication connection(s) 1326 may include, but is not limited to, a modem, a Network Interface Card (NIC), an integrated network interface, a radio frequency transmitter/receiver, an infrared port, a USB connection, or other interfaces for connecting computing device 1312 to other computing devices. Communication connection(s) 1326 may include a wired connection or a wireless connection. Communication connection(s) 1326 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1312 may include input device(s) 1324 such as keyboard, mouse, pen, voice input device, touch input device, infrared cameras, video input devices, and/or any other input device. Output device(s) 1322 such as one or more displays, speakers, printers, and/or any other output device may also be included in device 1312. Input device(s) 1324 and output device(s) 1322 may be connected to device 1312 via a wired connection, wireless connection, or any combination thereof. In one embodiment, an input device or an output device from another computing device may be used as input device(s) 1324 or output device(s) 1322 for computing device 1312.

Components of computing device 1312 may be connected by various interconnects, such as a bus. Such interconnects may include a Peripheral Component Interconnect (PCI), such as PCI Express, a Universal Serial Bus (USB), firewire (IEEE 13134), an optical bus structure, and the like. In another embodiment, components of computing device 1312 may be interconnected by a network. For example, memory 1318 may be comprised of multiple physical memory units located in different physical locations interconnected by a network.

Those skilled in the art will realize that storage devices utilized to store computer readable instructions may be distributed across a network. For example, a computing device 1330 accessible via a network 1328 may store computer readable instructions to implement one or more embodiments provided herein. Computing device 1312 may access computing device 1330 and download a part or all of the computer readable instructions for execution. Alternatively, computing device 1312 may download pieces of the computer readable instructions, as needed, or some instructions may be executed at computing device 1312 and some at computing device 1330.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for assigning influence values to nodes within a graph comprising:
for respective edges between nodes within a graph, concurrently determining whether an edge is activated or deactivated;
concurrently determining one or more node groupings, a node grouping comprising one or more nodes connected with activated edges; and
for respective node groupings, assigning influence values to respective nodes within a node grouping, the influence value corresponding to a node count of the node grouping.

2. The method of claim 1, an edge comprising an influence probability between a node pairing.

3. The method of claim 1, the concurrently determining whether an edge is activated or deactivated comprising:
performing a random function on an edge.

4. The method of claim 3, comprising:
weighting the random function based upon an influence probability of the edge.

5. The method of claim 1, the graph representing a social network, a node representing a user within the social network, and an edge representing an influence probability between a user pairing.

6. The method of claim 1, the graph being a directed graph.

7. The method of claim 1, comprising:
determining an influential node within the graph having, the influential node a desired influence value.

8. The method of claim 7, comprising:
determining an influential node pairing comprising the influential node and a node other than the influential node within the graph, the influential node pairing comprising a desired pairing influence value.

9. The method of claim 8, comprising:
determining the influential node pairing, comprising, after determining the influential node:
for respective edges between nodes within the graph, concurrently determining whether an edge is activated or deactivated;
concurrently determining one or more node groupings, a node grouping comprising one or more nodes connected with activated edges;
for respective node groupings, assigning influence values to respective nodes within a node grouping, the influence value corresponding to a node count of the node grouping;
for respective node pairings, assigning a pairing influence value to a node pairing comprising the influential node and a non-influential node other than the influential node, the pairing influence value based at least in part on an influence value of the influential node and an influence value of the non-influential node within the node pairing; and
determining the influential node pairing as a node pairing having a pairing influence value corresponding to the desired pairing influence value.

10. The method of claim 9, the assigning a pairing influence value comprising:
if a non-influential node is comprised within a node grouping comprising the influential node, then assigning an influence value of the non-influential node as the pairing influence value; and
if a non-influential node is comprised within a node grouping different than a node grouping comprising the influential node, then assigning a sum of the influence value of the non-influential node and the influence value of the influential node as the pairing influence value.

11. A method for selecting one or more nodes within a graph, comprising:
for respective nodes within a graph interconnected by edges, assigning a degree to a node based upon an edge count of the node;
selecting a first node having a desired degree;
for respective neighboring nodes connected to the first node, discounting a degree of a neighboring node based upon a discount value; and
selecting a second node different than the first node, the second node having a second desired degree.

12. The method of claim 11, comprising:
for respective neighboring nodes connected to the second node, discounting a degree of a neighboring node based upon a second discount value.

13. The method of claim 11, respective edges comprising a substantially uniform influence probability.

14. The method of claim 11, an edge comprising an influence probability.

15. The method of claim 14, comprising:
calculating the discount value based upon at least one of respective degrees of neighboring nodes and respective influence probabilities of edges between the first node and neighboring nodes.

16. A method for determining a node having a desired influence within a graph comprising:
for respective nodes within a graph interconnected by edges, constructing a tree associated with a current node, the tree comprising edges associated with influential paths from non-current nodes to the current node;
for respective trees, assigning path influence probabilities to non-current nodes within a tree;
for respective nodes within the graph, determining a total path influence probability based upon respective path influence probabilities; and
determining a first node having a desired total path influence probability.

17. The method of claim 16, constructing a tree comprising excluding non-current nodes having an undesired influence probability.

18. The method of claim 17, the assigning path influence probabilities comprising:
for respective non-current nodes within a tree, calculate a path influence probability of a non-current node to the current node based upon one or more influence probabilities of edges connecting the non-current node to the current node within the tree.

19. The method of claim 16, comprising:
for respective trees, updating path influence probabilities of nodes other than the first node based upon a path influence probability of the first node within a tree comprising the nodes other than the first node.

20. The method of claim 19, comprising:
determining a second node having a second desired total influence probability.
